(19) United States
(12) Patent Application Publication
(10) Pub. No.: US 2012/0164505 A1
(43) Pub. Date: Jun. 28, 2012

(54) ENERGY FEEDBACK LOOP

(75) Inventors: Brian Baxter, Greensboro, NC (US); Roman Zbigniew Arkiszewski, Oak Ridge, NC (US)

(73) Assignee: RF MICRO DEVICES, INC., Greensboro, NC (US)

(21) Appl. No.: 12/975,911

(22) Filed: Dec. 22, 2010

(51) Int. Cl. H01M 10/50; H01M 2/30

(52) U.S. Cl. 429/120; 429/121

(57) ABSTRACT

A battery assembly for a mobile communication device includes a battery having a mounting surface, wherein a capacity of the battery increases with temperature. The battery assembly further includes a power amplifier assembly mounted to the mounting surface of the battery. The power amplifier assembly includes a power amplifier in thermal communication with the battery and a circuit board configured to receive the power amplifier, wherein the power amplifier is mounted to the circuit board. Generated heat from the power amplifier is transferred to the battery in order to increase the capacity of the battery in a given temperature environment.

### FIELD OF THE DISCLOSURE

This application relates recycling power generated by an electrical device to improve the capacity of a battery. The application further relates to recycling waste power from a power amplifier to improve the charge capacity of a battery used in an electronic device.

### BACKGROUND

Demand for highly-integrated mobile devices has increased dramatically. In addition, consumers desire more power-intensive applications and continuous availability to communication networks. Simultaneously, the size and profile of these devices have shrunk. As a result, smaller battery profiles are required to provide increased charge capacity and improved battery lifetime over the operating range of the mobile devices.

Accordingly, there is a need to develop a method for increasing the charge capacity and energy availability of batteries while maintaining a smaller profile.

### SUMMARY OF THE DETAILED DESCRIPTION

Embodiments in the detailed description are related to improving the operational capacity of batteries typically used in a variety of electronic devices. In addition, the embodiments are further related to techniques to extend battery capacity or energy deliverable by a battery at a given temperature by taking advantage of the relationship between temperature and battery charge capacity over the normal operating range of the variety of electronic devices. As will be explained in further detail below, some battery materials demonstrate improved charge capacity as the temperature of the battery material is increased. An example battery material that demonstrates this advantageous relationship is LiFePO₄ battery technology.

In order to take advantage of the physical properties of the LiFePO₄ battery technology, heat from an electronic device may be used to extend the charge capacity of LiFePO₄-based batteries over a given operating range. As an example, in the case of a mobile communication device, the heat generated by a power amplifier may be used to raise the operating temperature of a battery that generally exhibits higher capacity at higher temperatures.

A first exemplary embodiment includes a battery assembly for a mobile communication device. The battery assembly includes a battery having a mounting surface, a positive power terminal and a negative power terminal. The battery exhibits a higher available capacity as the temperature of the battery increases. The battery assembly further includes a power amplifier assembly mounted to the mounting surface of the battery. The power amplifier assembly includes a power amplifier thermally coupled to the battery and the circuit board configured to receive the power amplifier, wherein the power amplifier is mounted to the circuit board.

Another exemplary embodiment includes a battery interface for a device including a first coaxial interface configured to connect to a first coaxial connector of a battery assembly. The battery interface further includes a second coaxial interface configured to connect to a second coaxial connector of the battery assembly. The battery interface may further include a first power terminal adapted to contact a first terminal of the battery assembly and a second power terminal adapted to contact a second terminal of the battery assembly.

Still another exemplary embodiment includes a mobile terminal further comprising a power interface including a positive terminal connector and a negative terminal connector, wherein the positive terminal connector is configured to be in communication with a positive power terminal of a battery and the negative terminal connector is configured to be in communication with a negative power terminal of the battery. The mobile terminal may further include a power amplifier heat sink thermally coupled to a power amplifier of the mobile terminal, wherein the power amplifier heat sink is configured to couple with a battery heat sink of an integrated battery assembly.

Another exemplary embodiment includes a mobile terminal having a power amplifier heat sink configured to receive a battery. The battery may include a battery heat sink and exhibit a higher operating capacity as battery temperature increases. The mobile terminal may further include a power amplifier in communication with the power amplifier heat sink. The power amplifier heat sink is in contact with the battery heat sink and communicates a portion of thermal energy generated by the power amplifier to the battery.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure, and together with the description serve to explain the principles of the disclosure.

FIGS. 1(a)-(b) depict thermal characteristics of a battery based upon LiFePO₄ battery technology.

FIG. 2 depicts a top perspective view of an integrated battery module.

FIG. 3 depicts a bottom perspective view of the integrated battery module of FIG. 2.

FIG. 4 depicts cutaway views of the integrated battery module 10 of FIGS. 2 and 3.

FIG. 5 depicts a perspective view of a battery power amplifier assembly before a conformal shield is added over the power amplifier.

FIG. 6 depicts a perspective view of the battery power amplifier assembly, of FIG. 5, after a conformal shield is added to the power amplifier assembly.

FIG. 7 depicts a perspective view of another embodiment of an integrated battery assembly.

FIG. 8 depicts a perspective view of a mobile terminal device that includes a battery receiving cavity for receipt of the integrated battery assembly of FIG. 7.

FIG. 9 depicts a perspective view of the integrated battery assembly of FIG. 7 installed into the battery receiving cavity of the mobile terminal device of FIG. 8.

FIG. 10 depicts a side profile view of the integrated battery assembly of FIG. 7 placed in the battery receiving cavity of FIG. 8.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Embodiments in the detailed description are related to improving the operational capacity of batteries typically used in a variety of electronic devices. In addition, the embodiments are further related to techniques to extend battery capacity by taking advantage of the relationship between temperature and battery capacity over the normal operating range of the variety of electronic devices. As will be explained in further detail below, some battery materials demonstrate improved charge capacity as the temperature of the battery material is increased. An example battery material that demonstrates this advantageous relationship is LiFePO₄ battery technology.

In order to take advantage of the physical properties of the LiFePO₄ battery technology, heat from an electronic device may be used to increase the available energy from a battery at a given temperature, which thereby extends the charge capacity of LiFePO₄-based batteries over a given operating range. As an example, in the case of a mobile communication device, the heat generated by a power amplifier may be used to raise the operating temperature of a battery that exhibits higher charge capacity and energy availability at higher temperatures.

A first exemplary embodiment includes a battery assembly for a mobile communication device. The battery assembly includes a battery having a mounting surface, a positive power terminal and a negative power terminal. The battery exhibits a higher available capacity as the temperature of the battery increases. The battery assembly further includes a power amplifier assembly mounted to the mounting surface of the battery. The power amplifier assembly includes a power amplifier thermally coupled to the battery and the circuit board configured to receive the power amplifier, wherein the power amplifier is mounted to the circuit board.

A first exemplary embodiment includes a battery assembly for a mobile communication device. The battery assembly includes a battery having a mounting surface, a positive power terminal and a negative power terminal. The battery exhibits a higher available capacity as the temperature of the battery increases. The battery assembly further includes a power amplifier assembly mounted to the mounting surface of the battery. The power amplifier assembly includes a power amplifier in thermal communication with the battery and a circuit board configured to receive the power amplifier, wherein the power amplifier is mounted to the circuit board.

Another exemplary embodiment includes a battery interface for a device including a first coaxial interface configured to connect to a first coaxial connector of a battery assembly. The battery interface further includes a second coaxial interface configured to connect to a second coaxial connector of the battery assembly. The battery interface may further include a first power terminal adapted to contact a first terminal of the battery assembly and a second power terminal adapted to contact a second terminal of the battery assembly.

Still another exemplary embodiment includes a mobile terminal further comprising a power interface including a positive terminal connector and a negative terminal connector, wherein the positive terminal connector is configured to be in communication with a positive power terminal of a battery and the negative terminal connector is configured to be in communication with a negative power terminal of the battery. The mobile terminal may further include a power amplifier heat sink thermally coupled to a power amplifier of the mobile terminal, wherein the power amplifier heat sink is configured to couple with a battery heat sink of an integrated battery assembly.

Another exemplary embodiment includes a mobile terminal having a power amplifier heat sink configured to receive a battery. The battery may include a battery heat sink and exhibit a higher operating capacity as battery temperature increases. The mobile terminal may further include a power amplifier in communication with the power amplifier heat sink. The power amplifier heat sink is in contact with the battery heat sink and communicates a portion of thermal energy generated by the power amplifier to the battery.

An energy feedback loop may be used in devices that utilize batteries that exhibit higher capacity at higher temperatures. An example of such a battery technology is LiFePO₄. The energy feedback loop takes advantage of the chemical energy stored in the battery, which may be transformed into electrical energy. The electrical energy is used to power electronic circuits or other electromechanical devices. Because devices are not 100% efficient, devices generate heat that can be recycled. The waste thermal energy is then fed back to the battery, which raises the temperature of the battery. As the temperature of the battery increases, the capacity of the battery also increases.

The energy feedback loop can be applied to mobile wireless devices where the power amplifier (PA) is a major source of excess heat. The battery capacity may be increased by transferring the excess thermal energy to the battery. The net result is a talk time increase due to strategic placement of the power amplifier and energy feedback. Several options are available to facilitate heat transfer. The power amplifier may be packaged directly with the battery, or the power amplifier and battery may be positioned such that complementary heat-sinks on the individual components are aligned.

As an alternative example, the energy feedback loop may also be used in automotive applications where one or more electric motors are the primary source of excess heat. Heat generated by these motors can be utilized to increase battery charge capacity. The net result is increased vehicle range through the use of energy feedback.

An example battery technology is a LiFePO₄-based battery, which has higher capacity as temperatures increase. During normal operation and over an operational temperature range, chemical energy stored in the LiFePO₄ battery is transformed to electrical energy. The electrical energy is used to power electronic circuits or other electromechanical devices. Because circuits and other devices are not 100% efficient, they will generate thermal energy that may be fed back to the battery to raise the battery temperature.

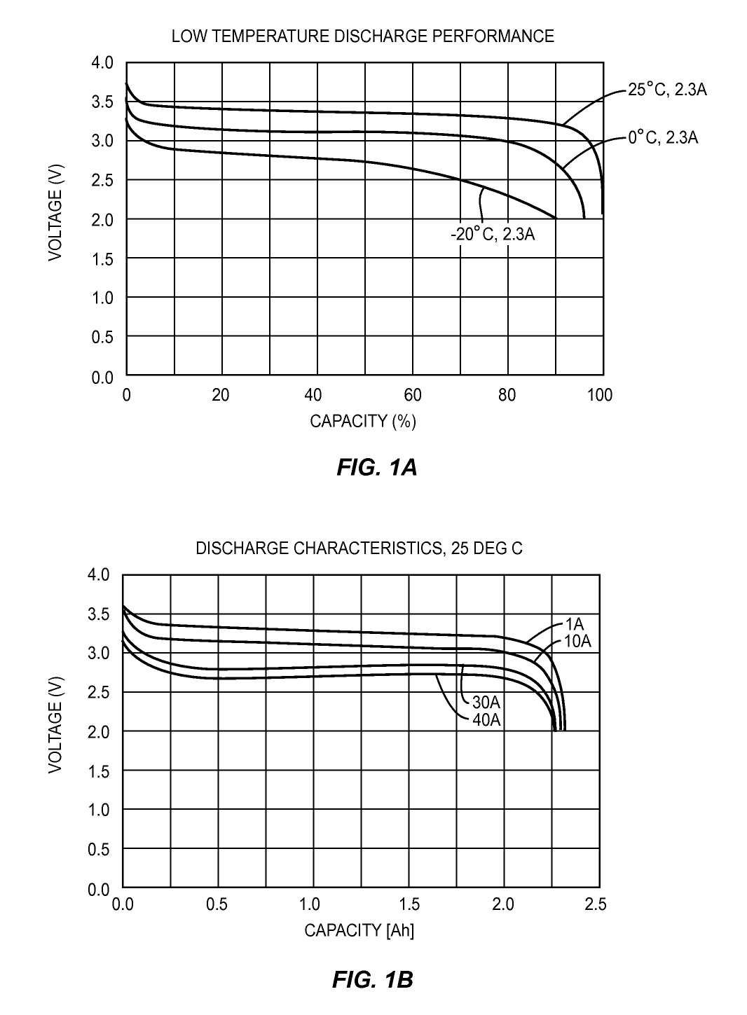

FIG. 1(a) depicts typical discharge curves for a LiFePO₄ battery used in an exemplary mobile communication device. The LiFePO₄ battery discharge curves indicate that over a normal operating temperature range, as a temperature of the battery is increased, the battery has a higher nominal voltage and discharge capacity as measured in ampere-hours (Ah). Based upon a minimum operating voltage of 2.8V, the curves depicted in FIG. 1(a) indicate a 60% reduction in capacity due to a temperature shift from 25° C. to −20° C.

Continuing with FIG. 1(b), specific heat is a figure of merit that indicates the amount of energy needed to raise a unit mass of a particular material by one degree Celsius. The measured specific heat of a Lithium-ion battery is 1070 J/kg*° C. Accordingly, 1070 watts may raise 1 kilogram of a Lithium polymer battery by approximately one degree Celsius in one second.

As an example, the average battery mass of a battery is 0.070 kg. The power amplifier of a wireless mobile device may have a 50% duty cycle with a maximum output power of two watts, and a power amplifier efficiency of 40%. Accordingly, approximately 3 watts of power delivered to the power amplifier are dissipated as thermal energy. Accordingly, the time to heat (T_{H}) the example battery is approximately 50 seconds/° C., where:

$$\begin{matrix}{T}_{H} = [ ( specific heat * mass ) / ( dissipated heat * duty cycle ) ] = \\ = [ ( 1070 * 0.07 ) / ( 3 * .50 ) ] \\ = 50 sec {/}^{∘} C .\end{matrix} \qquad ( 1 )$$

Thus, the time to raise the temperature (T_{RT}) of the example battery by 20° C. may be approximately 16.6 minutes, where:

$$\begin{matrix}{T}_{RT} {20}^{∘} C . = 20 degrees * 50 seconds {/}^{∘} C . \\ = 1000 seconds or 16.6 minutes .\end{matrix} \qquad ( 2 )$$

Based upon the typical discharge curves for a LiFePO₄-based battery depicted in FIG. 1(b), the potential increase in battery capacity is dependent on the starting temperature of the battery. If the battery temperature starts at −20° C., 16 minutes at a 50% duty cycle will raise the temperature to 0° C. and more than double the useful battery life. Starting at 0° C., 21 minutes at a 50% duty cycle will raise the temperature to 25° C. and increase battery life by 19%. As a point of comparison, to achieve the same increases in battery life the PA efficiency would have to increase to 80% (0° C.).

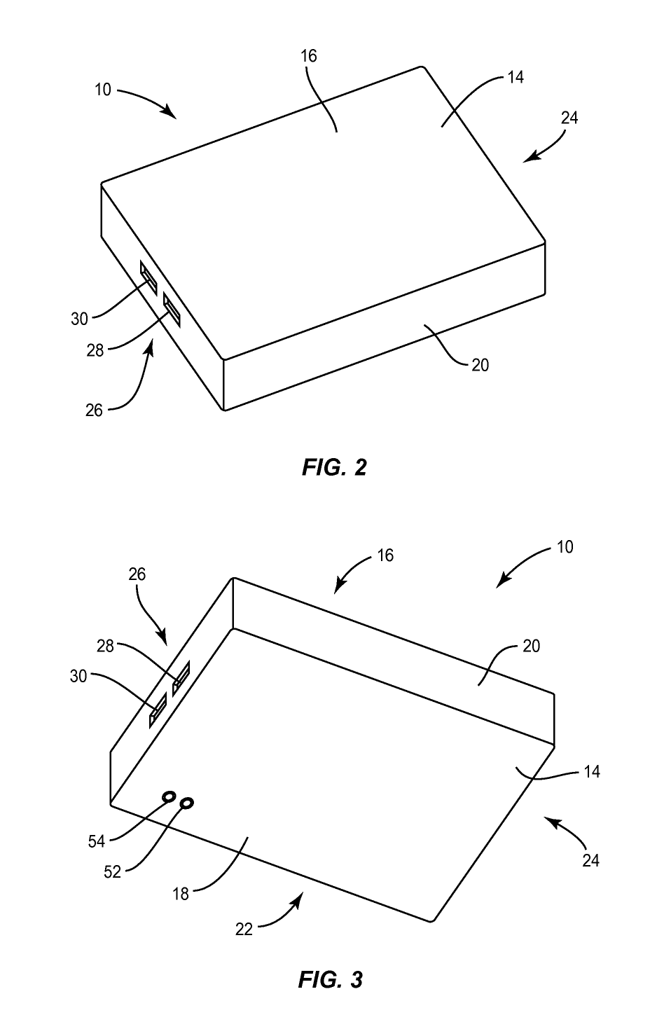

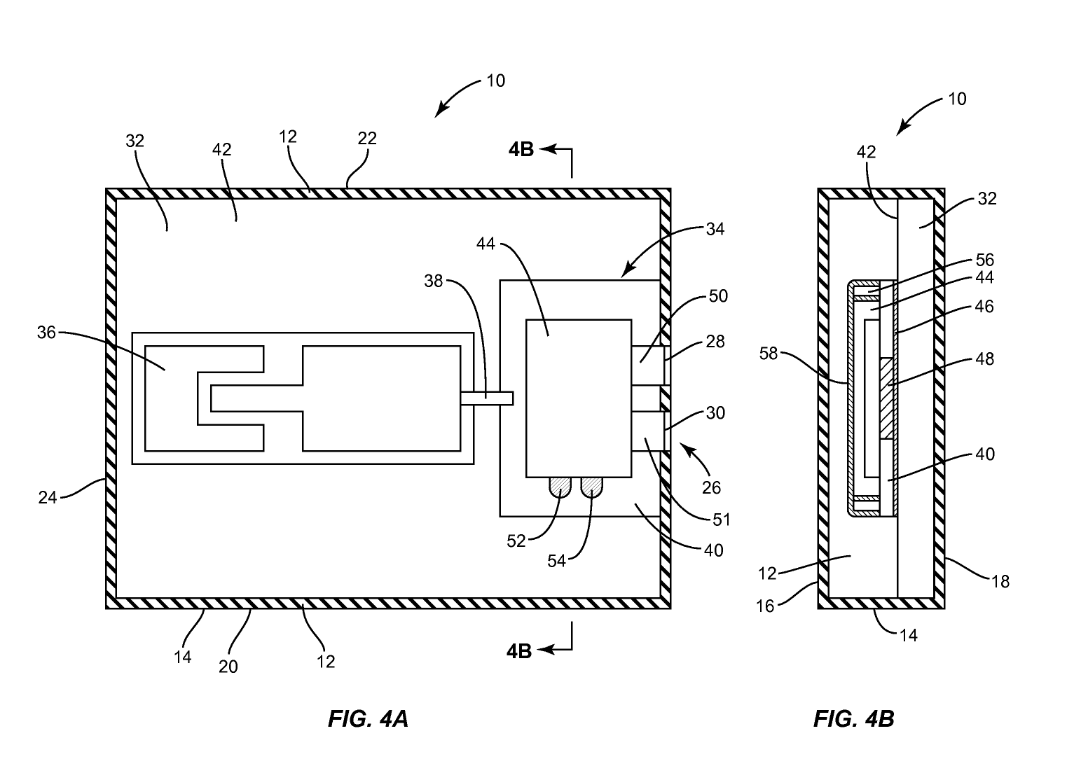

FIG. 2 depicts a top perspective view of an integrated power amplifier antenna, and battery module 10, hereinafter integrated battery module 10. The integrated battery module 10 includes battery packaging material 12, as shown in FIG. 4, which forms the outer cover 14 of the integrated battery module 10. The integrated battery module 10 includes a top surface 16, a bottom surface 18, and a first side 20, a second side 22, a third side 24, and a battery interface coupling 26. The battery interface coupling 26 includes a positive power terminal 28 coupled to a positive terminal of the battery (not shown) and a negative power terminal 30 coupled to a negative terminal of the battery (not shown).

FIG. 3 depicts a bottom perspective view of the integrated battery module 10 and battery interface coupling 26.

FIG. 4 depicts cutaway views of the integrated battery module 10. FIG. 5 depicts a perspective view of the integrated battery module. The integrated battery module 10 includes a battery packaging material 12 surrounding a battery 32, a power amplifier assembly 34, and an antenna 36. The antenna 36 and the power amplifier assembly 34 are mounted to a surface of the battery 32. The power amplifier assembly 34 is thermally coupled to the surface of the battery 32. The battery 32 may include a thermal heat spreader (not shown) to which the power amplifier assembly 34 is thermally coupled. The antenna 36 is coupled to the power amplifier assembly 34 via an antenna interconnect interface 38.

The power amplifier assembly 34 may further include a molded thermal epoxy 56 to encase the power amplifier integrated circuit 44 and a conformal shield 58 over the molded thermal epoxy 56.

The power amplifier integrated circuit 44 may include a power terminal 50 and a common terminal 51. The power terminal 50 may be coupled to the positive power terminal 28 of the battery 32. The common terminal 51 may be coupled to the negative power terminal 30 of the battery 32. The power amplifier integrated circuit 44 may further include an enable input (not shown). When the enable input is asserted, the power amplifier integrated circuit 44 is enabled and powered on. When the enable input is de-asserted, the power amplifier integrated circuit 44 is disabled and powered off.

The power amplifier assembly 34 includes a circuit board 40 coupled to the top surface 42 of the battery 32 and a power amplifier integrated circuit 44. The power amplifier integrated circuit 44 may be thermally coupled through the circuit board 40 to the top surface 42 of the battery 32. The circuit board 40 may be a ceramic circuit board, a printed circuit board, a circuit board having a thermal sink; or a ceramic circuit board having a thermal well, thermal heat sink or thermal slug.

The circuit board 40 may further include a heat spreader surface 46 coupled to the thermal sink 48, which communicates the thermal energy generated by a power amplifier integrated circuit 44 to the battery 32. The circuit board 40 may further include a radio frequency output coaxial interface 52 and a radio frequency input coaxial interface 54. The circuit board 40 may further include a positive power terminal 28 and a negative power terminal 30 configured to couple to a battery interface coupling 26 of various types of devices. Example devices may include a mobile phone, mobile terminal, a personal digital assistant, a computer, or a computational device.

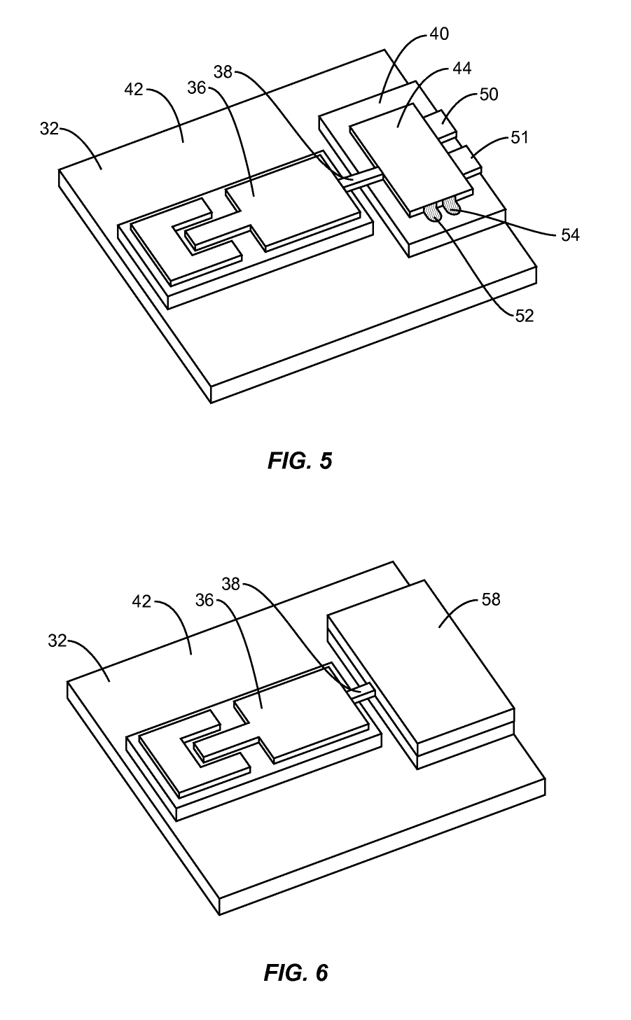

FIG. 5 depicts a perspective view of the battery-power amplifier assembly 60 before a conformal shield is added over the power amplifier integrated circuit 44 and adjoining circuitry, as illustrated in FIGS. 3 and 4. FIG. 6 depicts a perspective view of the battery-power amplifier assembly 60 illustrated in FIG. 5 after the conformal shield 58 is added to the power amplifier assembly 34.

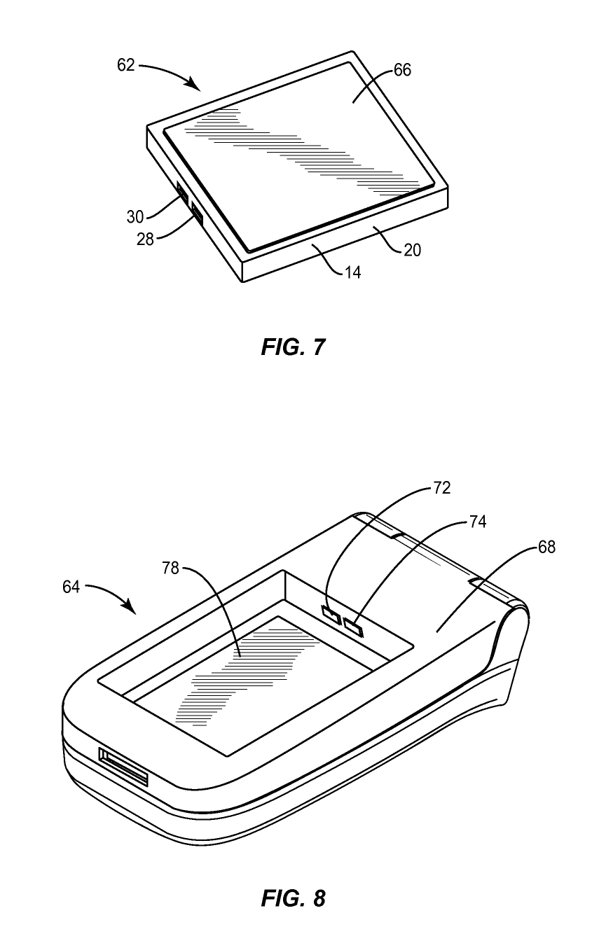

FIG. 7 depicts a perspective view of another embodiment of an integrated battery assembly 62 that may be configured to mount into a battery receiving cavity 64, as shown in FIG. 8. As depicted in FIG. 7, the integrated battery assembly 62 may be formed in part by a battery heat sink 66, which conducts thermal energy to the battery portion (not shown) of the integrated battery assembly 62.

FIG. 8 depicts a perspective view of a mobile terminal device 68 that includes a battery receiving cavity 64 for receiving the integrated battery assembly 62 illustrated in FIG. 7. The battery receiving cavity 64 includes a power amplifier heat sink 78 configured to mate with the battery heat sink 66 of the integrated battery assembly 62, illustrated in FIG. 7. A thermal grease or thermal tape may be inserted between the battery heat sink 66 and the power amplifier heat sink 78 to improve thermal conductivity. The battery receiving cavity 64 further includes a positive terminal connector 72 configured to mate with the positive power terminal 28 of the integrated battery assembly 62. The battery receiving cavity 64 also includes a negative terminal connector 74 configured to mate with the negative power terminal 30 of the integrated battery assembly 62. The battery heat sink 66 is configured to mate with the battery portion, as shown in FIG. 7, and mates with a corresponding power amplifier heat sink 78.

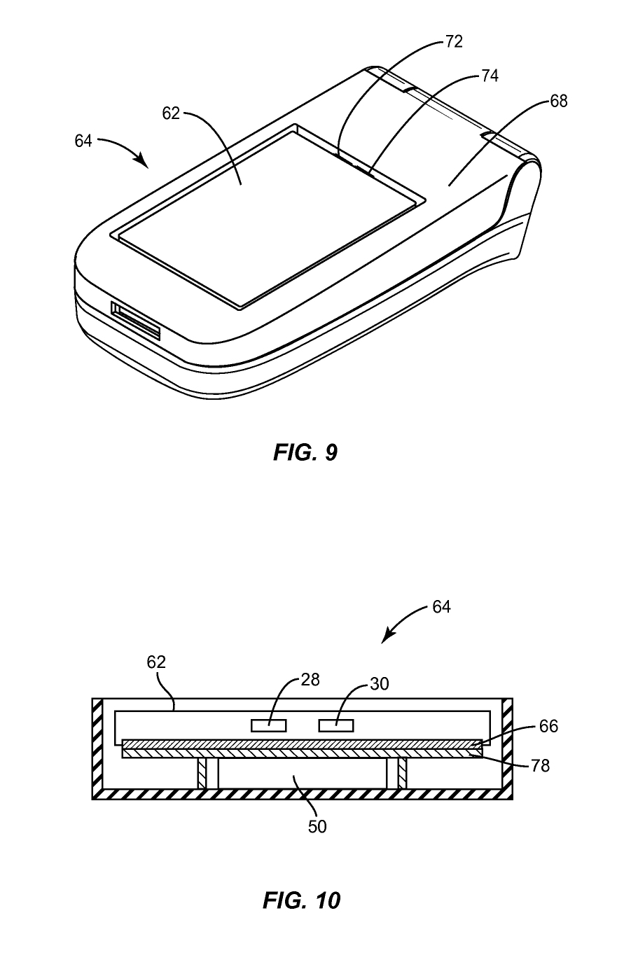

FIG. 9 depicts a perspective view of the integrated battery assembly 62 of FIG. 7 installed into the battery receiving cavity 64 of the mobile terminal device 68, as illustrated in FIG. 8.

FIG. 10 depicts a side profile view of the integrated battery assembly 62 placed in the battery receiving cavity 64, as shown in FIG. 9. The battery heat sink 66 rests upon the power amplifier heat sink 78. Thermal energy from the power amplifier integrated circuit 44 is conducted into the power amplifier heat sink 78. The transferred thermal energy is then conducted from the power amplifier heat sink 78, through the battery heat sink 66, to the battery portion (not shown) of the integrated battery assembly 62. The power amplifier 50 may include a thermal slug (not shown), which is substantially in thermal contact with the power amplifier heat sink 78. Alternatively, a power amplifier assembly 34 may be mounted to the power amplifier heat sink 78.

Those skilled in the art will recognize improvements and modifications to the embodiments of the present disclosure. All such improvements and modifications are considered within the scope of the concepts disclosed herein and the claims that follow.

What is claimed is:

1. A battery assembly for a mobile communication device comprising:
a battery having a mounting surface and wherein the battery includes a positive power terminal and a negative power terminal;
a power amplifier assembly mounted to the mounting surface of the battery, wherein the power amplifier assembly includes:
a power amplifier thermally coupled to the battery through a circuit board; and
the circuit board configured to receive the power amplifier, wherein the power amplifier is mounted to the circuit board.

2. The battery assembly of claim 1 wherein the circuit board further includes a heat spreader thermally coupled to the mounting surface of the battery; and
wherein the power amplifier is thermally coupled to the heat spreader through the circuit board.

3. The battery assembly of claim 2 wherein the circuit board includes a thermal well, and wherein the thermal well thermally couples the heat spreader to the power amplifier.

4. The battery assembly of claim 1 further comprising:
an antenna disposed upon the mounting surface of the battery, wherein the antenna is in communication with the power amplifier.

5. The battery assembly of claim 1 further comprising:
a first coaxial input connection coupled to the power amplifier, wherein the first coaxial input connection is adapted to receive a first RF signal; and
a second coaxial input connection coupled to the power amplifier, wherein the second coaxial input connection is adapted to output a second RF signal.

6. The battery assembly of claim 1 wherein the circuit board onto which the power amplifier is mounted further includes a thermally conductive well coupled to a heat spreader.

7. The battery assembly of claim 1 further comprising:
a conformal shield disposed on the power amplifier.

8. The battery assembly of claim 1 wherein the battery includes LiFePO₄.

9. The battery assembly of claim 1 wherein the battery includes a first power terminal and a second power terminal,
wherein the power amplifier includes a first power terminal coupled to the first power terminal of the battery and a common power terminal coupled to the second power terminal of the battery.

10. The battery assembly of claim 1, wherein the power amplifier has a power terminal and a common terminal; and wherein the power terminal is coupled to the positive power terminal of the battery, and the common terminal is coupled to the negative power terminal of the battery.

11. A battery interface for a device further comprising:
a first coaxial interface configured to connect to a first coaxial connector of a battery assembly;
a second coaxial interface configured to connect to a second coaxial connector of the battery assembly;
a first power terminal adapted to contact a first terminal of the battery assembly; and
a second power terminal adapted to contact a second terminal of the battery assembly.

12. The battery interface of claim 11 wherein the battery assembly includes a power amplifier configured to receive a power amplifier enable signal, the battery interface further comprising a power amplifier enable output configured to provide the power amplifier enable signal.

13. A mobile terminal further comprising:
a power interface including a positive terminal connector and a negative terminal connector, wherein the positive terminal connector is configured to be in communication with a positive power terminal of a battery and the negative terminal connector is configured to be in communication with a negative power terminal of the battery;
a power amplifier heat sink thermally coupled to a power amplifier of the mobile terminal, wherein the power amplifier heat sink is configured to couple with a battery heat sink of an integrated battery assembly.

14. The mobile terminal of claim 13 wherein the battery includes LiFePO₄.

15. A mobile terminal comprising:
a power amplifier heat sink configured to receive a battery including a battery heat sink; and
a power amplifier in communication with the power amplifier heat sink, wherein a portion of thermal energy generated by the power amplifier is communicated to the battery.

16. The mobile terminal of claim 15 wherein the power amplifier includes a thermal slug; and
wherein the thermal slug is substantially in thermal contact with the power amplifier heat sink.
